(19) United States
(12) Patent Application Publication
(10) Pub. No.: US 2025/0303482 A1
(43) Pub. Date: Oct. 2, 2025

(54) APPARATUS FOR CENTERING A PILOT TOOL WITHIN A VALVE GUIDE DURING VALVE SEAT CUTTING

(71) Applicant: VAN NORMAN MACHINE (INDIA) PVT LTD, Chandigarh (IN)

(72) Inventor: RANJIT (ROBIN) Mahendra CHERA, Chandigarh (IN)

(21) Appl. No.: 18/670,759

(22) Filed: May 22, 2024

(30) Foreign Application Priority Data
Mar. 29, 2024 (IN) 202411026274

(51) Int. Cl. B23C 3/05

(52) U.S. Cl. CPC B23C 3/05

(57) ABSTRACT

An apparatus for centering a pilot tool within a valve guide during valve seat cutting is disclosed. The apparatus includes a pilot tool and an adapter. The pilot tool includes a shank, and an extended section extending from the shank. The extended section includes an upper section and a lower section. The upper section extends from the shank, and the lower section extends from the upper section. The upper section includes a tapered section, and the lower section includes a straight section. The adapter receives the shank. In one embodiment, the upper section engages with the valve guide to operate the pilot tool as a fixed pilot to center within the valve guide. In another embodiment, the lower section operatively contacts the valve guide. The adapter rotates causing the lower section to rotate within the valve guide, and operate the pilot tool as a live pilot for centering within the valve guide.

### TECHNICAL FIELD

The present disclosure relates to machining tools, and in particular, relates to an apparatus comprising an adapter and a tool for centering a pilot tool within a valve guide during valve seat cutting in a cylinder head of an internal combustion (IC) engine.

### DESCRIPTION OF THE RELATED ART

As known, a cylinder head incorporates valves, valve seats, injector tubes, and related components and plays an important role in achieving the required performance and efficiency of internal combustion (IC) engines. Precise and reliable machining of the cylinder head is required to ensure optimal engine operation and durability.

The valve seats are critical components within the cylinder head as they are responsible for sealing between intake and exhaust valves and the cylinder itself. It is important to center the valve seats for their proper machining. Without proper centering of the valve seats, the valves may leak if there is any eccentricity (off-center positioning) between the valve seat and a valve guide bore. Further, improper centering may lead to valve chatter, damage to the valves and seat surfaces, and may create noise and performance issues.

Typically, the centering of the valve seats is achieved using a rod, commonly referred to as a “pilot tool” or “pilot rod”. The pilot tool acts as a guide for the valve seat cutting tool. The pilot tool fits within the valve guide and ensures the valve seat cutting tool follows the same centerline, resulting in a concentric valve seat. The pilot tool includes a tapered section, straight section, or other profile section that wedges in the valve guide bore for centering. The pilot tool having the tapered section is referred to as a “fixed pilot”. The tapered section in the fixed pilot design wedges itself into a tapered section of the valve guide for centering. The fixed pilot creates a secure and centered fit for a shank of the pilot tool. The pilot tool having the straight section or other profile section is referred to as a “live pilot”. The straight section in the live pilot design rotates within the valve guide with the rotation of a spindle and helps to center the valve seat.

Several pilot tool designs have been proposed in the past for centering a valve guide in a cylinder head. One such example is disclosed in a U.S. Pat. No. 5,613,809, entitled “Apparatus and method for machining valve seats in an engine cylinder head” (“the '809 Patent”). The '809 Patent discloses a valve seat and guide machine comprising a base structure on which is pivotally supported a pantograph having a major arm on which is mounted a drive motor and minor arm which moves slidably with respect to the major arm. Pivotally attached to each arm of the pantograph is a head portion with a support frame which retains a spherical head and a plurality of sphere seats for supporting the spherical head so that it can pivot around its centerpoint at the center of the sphere. A stepper motor is disposed at the top of the spherical head and a spindle disposed with the spherical head retains a cutting bit and a pilot which extend from the bottom of the spherical head. Small z-axis displacement and spindle feed/retraction along the z-(vertical) axis is provided by the stepper motor. The drive motor rotates a transmission linkage which, in turn, rotates the spindle using cone-shaped pinions to cause the cutting bit, typically carbide, to cut the valve scat. Small x,y displacements are enabled by moving the entire spherical housing and its supporting sphere seats with respect to the support frame. The pantograph swings up and down on the base to provide large z-axis displacement to remove the spindle from the cutting position and to provide clearance for movement to another machine site. A system controller receives feedback from system monitors to control spindle rotations and feed/retraction.

Although the above discussed disclosure and other existing fixed or live pilot tools for centering are useful, they have few problems. For instance, the fixed pilot is selected for standard valve seat machining operations with acceptable concentricity. However, due to its fixed nature, the fixed pilot may be restricted in accessing specific areas within the valve guide. Further, the fixed pilot has to be installed and uninstalled manually from one guide to another. As a result, the time to center all the valve guides is time consuming. In addition, the fixed pilot presents chatter/vibrations risk during machining. On the other hand, the live pilot is preferred for machining complex geometrics due to its rotational capability allowing it to access all surfaces within the valve guide bore. However, in some instances, the centering of the valve guide is more challenging with the live pilot than the fixed pilot. This is because; as the live pilot rotates with the spindle, the concentricity of the centering depends on accuracy of the pilot tool and/or spindle with respect to the valve seat. The choice of the fixed pilots and live pilots depends on the machining requirements, precise valve seat positioning, and concentricity required.

Most of the fixed pilots and the live pilots come as separate tools, indicating that either the fixed pilot or the live pilot can be used at a time for centering within the valve guide. As a result, if an operator has to switch from the fixed pilot to the live pilot, then the operator has to uninstall the fixed pilot from the valve guide, and install the live pilot to an adapter connecting to a spindle. Changing between the fixed pilot and the live pilot may take considerable time. Further, the industry has been using the same fixed pilots and/or the live pilots design for several decades without any improvements or modifications.

Therefore, there is a need in the art to provide an improved apparatus having an adapter, and a tool for centering within a valve guide in a cylinder head of an internal combustion (IC) engine.

### SUMMARY

It is an object of the present invention to provide an apparatus having an adapter and a 2-in-1 pilot tool that overcomes the drawbacks of the prior art.

It is another object of the present invention to provide an apparatus that offers both fixed and live pilot design in a single pilot tool, and an adapter to connect the pilot tool for using the pilot tool as a fixed pilot and a live pilot depending on the need.

It is another object of the present invention to provide an apparatus having a spring-loaded adapter allowing the pilot tool to be adjusted for using it as a fixed pilot and a live pilot.

In order to overcome one or more objects, the present invention provides an apparatus for centering a valve guide during seat valve cutting. The apparatus includes a pilot tool and an adapter. The pilot tool includes a shank, and an extended section extending from the shank. The extended section includes an upper section and a lower section. The upper section extends from the shank, and the lower section extends from the upper section. The upper section includes a tapered section, and the lower section includes a straight section. The adapter receives the shank. In one embodiment, the upper section engages with the valve guide to operate the pilot tool as a fixed pilot to center the valve guide. In another embodiment, the lower section operatively contacts the valve guide. In one example, the lower section contacts the valve guide with a clearance of about 10 microns. The adapter rotates causing the lower section to rotate within the valve guide, and operate the pilot tool as a live pilot for centering the valve guide.

In one aspect of the invention, the shank includes a spherical groove. Further, the adapter includes a sphere-ball loaded spring. The sphere-ball loaded spring slides over the surface of the shank and locks the shank to the adapter.

In one advantageous feature of the present invention, the pilot tool presents a two-in-one (2-in-1, or live+pilot, or hybrid pilot tool) pilot tool that offers both fixed and live pilot systems.

In another advantageous feature of the present invention, the pilot tool includes a spring. The spring positions at the top of the pilot tool and inserts into the adapter bore. The spring allows the pilot tool to be inserted into the adapter at different lengths. Further, the spring allows the pilot tool to move up and down to withstand or compensate for the compression forces encountered during the centering of the valve guide.

In another advantageous feature of the present invention, the pilot tool can be operated as the fixed pilot and the live pilot without having to remove manually, as in the prior art. In addition, the pilot tool moves within the spindle while being held in position by the ball-loaded spring or sphere-ball loaded spring.

The features and advantages of the invention here will become more apparent in light of the following detailed description of selected embodiments, as illustrated in the accompanying FIGURES. As will be realized, the invention disclosed is capable of modifications in various respects, all without departing from the scope of the invention. Accordingly, the drawings and the description are to be regarded as illustrative in nature.

### BRIEF DESCRIPTION OF THE DRAWINGS

The present invention will now be described in detail with reference to the drawings, which are provided as illustrative examples of the invention so as to enable those skilled in the art to practice the invention. Notably, the FIGURES and examples are not meant to limit the scope of the present invention to a single embodiment, but other embodiments are possible by way of interchange of some or all of the described or illustrated elements and, further, wherein:

FIG. 1 illustrates an apparatus for centering a valve guide connected to a machine, in accordance with one embodiment of the present invention;

FIG. 2 illustrates a front view of the apparatus including an adapter and a pilot tool, in accordance with one embodiment of the present invention;

FIG. 3 illustrates the pilot tool, in accordance with one embodiment of the present invention;

FIG. 4 illustrates the pilot tool utilized as a live pilot in the machine, in accordance with one embodiment of the present invention;

FIG. 5 illustrates an enlarged view of the pilot tool utilized as the live pilot, in accordance with one embodiment of the present invention;

FIG. 6 illustrates a schematic view of the pilot tool engaged as the live pilot within a valve guide, in accordance with one embodiment of the present invention;

FIG. 7 illustrates a perspective view of the pilot tool in operation inside the valve guide, in accordance with one exemplary embodiment of the present invention;

FIG. 8 illustrates the pilot tool utilized as a fixed pilot, in accordance with one embodiment of the present invention; and

FIG. 9 illustrates a schematic view of the fixed pilot engaged as the fixed pilot within the valve guide, in accordance with one embodiment of the present invention.

### DETAILED DESCRIPTION

The following detailed description set forth below in connection with the appended drawings is intended as a description of exemplary embodiments in which the presently disclosed invention may be practiced. The term “exemplary” used throughout this description means “serving as an example, instance, or illustration,” and should not necessarily be construed as preferred or advantageous over other embodiments. The detailed description includes specific details for providing a thorough understanding of the presently disclosed apparatus. However, it will be apparent to those skilled in the art that the presently disclosed invention may be practiced without these specific details. In some instances, well-known structures and devices are shown in functional or conceptual diagram form in order to avoid obscuring the concepts of the presently disclosed apparatus.

In the present specification, an embodiment showing a singular component should not be considered limiting. Rather, the invention preferably encompasses other embodiments including a plurality of the same component, and vice-versa, unless explicitly stated otherwise herein. Moreover, the applicant does not intend for any term in the specification to be ascribed an uncommon or special meaning unless explicitly set forth as such. Further, the present invention encompasses present and future known equivalents to the known components referred to herein by way of illustration.

Although the present invention provides a description of an apparatus, it is to be further understood that numerous changes may arise in the details of the embodiments of the apparatus. It is contemplated that all such changes and additional embodiments are within the spirit and true scope of this disclosure.

The following detailed description is merely exemplary in nature and is not intended to limit the described embodiments or the application and uses of the described embodiments. As used herein, the word “exemplary” or “illustrative” means “serving as an example, instance, or illustration.” Any implementation described herein as “exemplary” or “illustrative” is not necessarily to be construed as preferred or advantageous over other implementations. All of the implementations described below are exemplary implementations provided to enable persons skilled in the art to make or use the embodiments of the disclosure and are not intended to limit the scope of the disclosure.

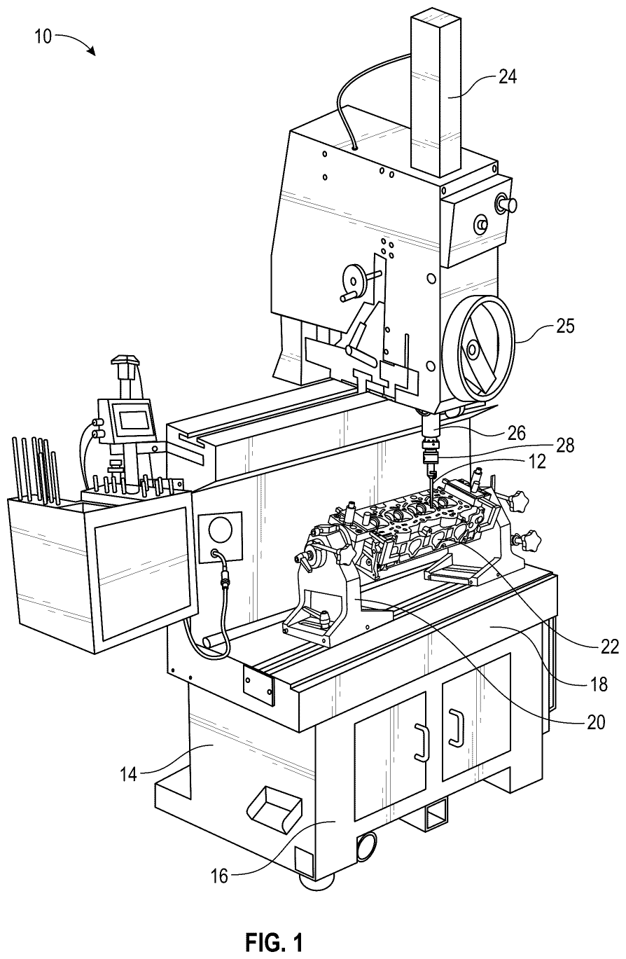

Various features and embodiments of an apparatus for centering a valve guide are explained in conjunction with the description of FIGS. 1-9.

FIG. 1 shows an environment 10 in which an apparatus 11 implements, in accordance with one embodiment of the present invention. Apparatus 11 includes a pilot tool 12 and an adapter 28. Pilot tool 12 indicates a rod or pilot rod, as shown in FIG. 3. Pilot tool 12 is used as a guide for a valve seat cutting tool used for valve seat machining. Pilot tool 12 fits within a valve guide 50 and ensures the valve seat cutting tool follows the same centerline to that of a spindle, resulting in a concentric valve seat. Apparatus 11 connects to a machine 14. In one example, machine 14 indicates a valve seat cutting machine or a valve seat and guide machine. Machine 14 includes a housing 16. Housing 16 presents a workbench 18 that is mounted on housing 16. In one example, workbench 18 is mounted on housing 16 by way of an air cushion platform which provides movement along the x, y plane. Workbench 18 includes cylinder head fixtures 20 for receiving a cylinder head 22. Further, machine 14 includes a working head 24 at the top. Working head 24 encompasses a hand wheel 25 for fine-tuning and making adjustments on the fly.

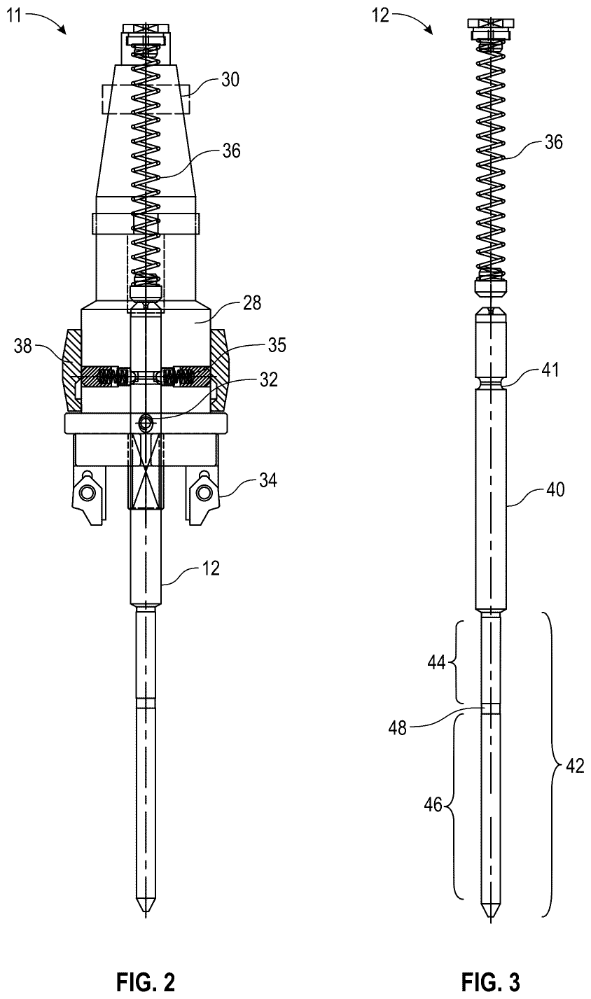

Further, working head 22 includes a spindle 26 for holding pilot tool 12. Spindle 26 receives an adapter or chuck 28 that holds pilot tool 12. FIG. 2 shows the feature of adapter 28 holding pilot tool 12, in accordance with one embodiment of the present invention. Adapter 28 includes a head 30. Head 30 inserts in spindle 26. One end of pilot tool 12 inserts in an adapter bore (not shown) that is centrally located in adapter 28. In one example, pilot tool 12 is secured to adapter 28 using a set screw 32. In some implementations, adapter 28 includes a pair of 3-angle adjustable tool or dual 3-angle adjustable tool 34. Dual 3-angle adjustable tool 34 helps to adjust a seat angle, a top angle and a throat angle. In one example, pilot tool 12 utilizes a spring 36. Spring 36 inserts in the adapter bore of adapter 28 and positions between pilot tool 12 and head 30, as can be seen in FIG. 2.

Further, adapter 28 encompasses a sphere-ball loaded spring 35. Sphere-ball loaded spring 35 configures to lock shank section 40 to adapter 28 by locking spherical groove 41 provided at shank section 40. Further, adapter 28 includes a sleeve 38. Sleeve 38 slides up and down to lock and unlock the movement of shank section 40 with respect to adapter 28.

FIG. 3 shows a front view of pilot tool 12, in accordance with one embodiment of the present invention. As presented above, pilot tool 12 encompasses spring 36 at the top for engaging adapter 28 at its adapter bore. Pilot tool 12 is made of carbide or any other suitable material. In accordance with one embodiment of the present invention, pilot tool 12 includes a shank section 40. Shank section 40 further includes a spherical groove 41. Spherical groove 41 positions along the length of shank section 40. In one example, spherical groove 41 positions closer to the distal end of shank section 40. In another example, spherical groove 41 positions at ¼^{th} to ⅓^{rd} length of shank section 40 at the top, as shown in FIG. 3. Spherical groove 41 allows locking shank section 40 to adapter 28. In order to connect shank section 40 to adapter 28, at first shank section 40 draws through the adapter bore. Subsequently, sphere-ball loaded spring 35 enters spherical groove 41 and locks shank section 40 to adapter 28. As specified above, pilot tool 12 includes spring 36 at the top of shank section 40. Spring 36 allows shank section 40 to be locked at different lengths into the adapter bore.

Further, pilot tool 12 includes an extended section 42. Extended section 42 extends from shank section 40 and forms a distal end of pilot tool 12. As can be seen from FIG. 3, extended section 42 presents a first section or upper section 44, a second section or lower section 46 separated by a gap portion or groove 48. In accordance with the present invention, first section 44 indicates a tapered section. Here, first section 44 tapers down i.e., has a wider diameter at shank end and narrows down at the intersection of second section 46 via gap portion 48. It should be understood that the diameter of first section 44 narrows down in predetermined microns as it extends down. Further, second section 46 presents a straight section i.e., has a cylindrical/parallel configuration. The length of each first section 44 and second section 46 may be changed based on the operation to be performed. In some embodiments, second section 46 is longer than first section 44, or vice versa. In some embodiments, the length of first section 44 is same as second section 46. Each of first section 44 and second section 46 has a suitable size and diameter based on the specification of the valve seat to be machined for proper alignment and accurate cutting.

As known, pilot tool 12 acts as a guide for the valve seat cutting tool used for valve seat machining. Here, pilot tool 12 fits within valve guide bore 50 and ensures the valve seat cutting tool follows the same centerline, resulting in a concentric valve seat. The presently disclosed pilot tool 12 presents both tapered section and straight section in a single tool/rod. As such, a single pilot tool 12 can be used for operating it as a fixed pilot and a live pilot. Specifically, first section 44 having the tapered section is utilised to operate pilot tool 12 as the fixed pilot. In another implementation, second section 46 having the straight section is utilised to operate pilot tool 12 as the live pilot. As known in the art, the tapered section in the fixed pilot design wedges itself into a tapered section of the valve guide for centering. The fixed pilot creates a secure and centered fit for a shank of the pilot. The pilot tool having the straight section or other profile section is referred to as a “live pilot”. The straight section in the live pilot design rotates within the valve guide and helps to center the valve scat.

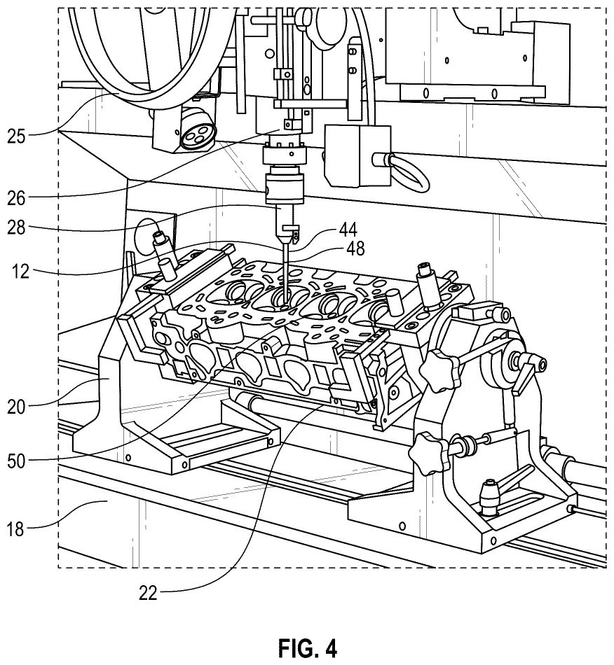

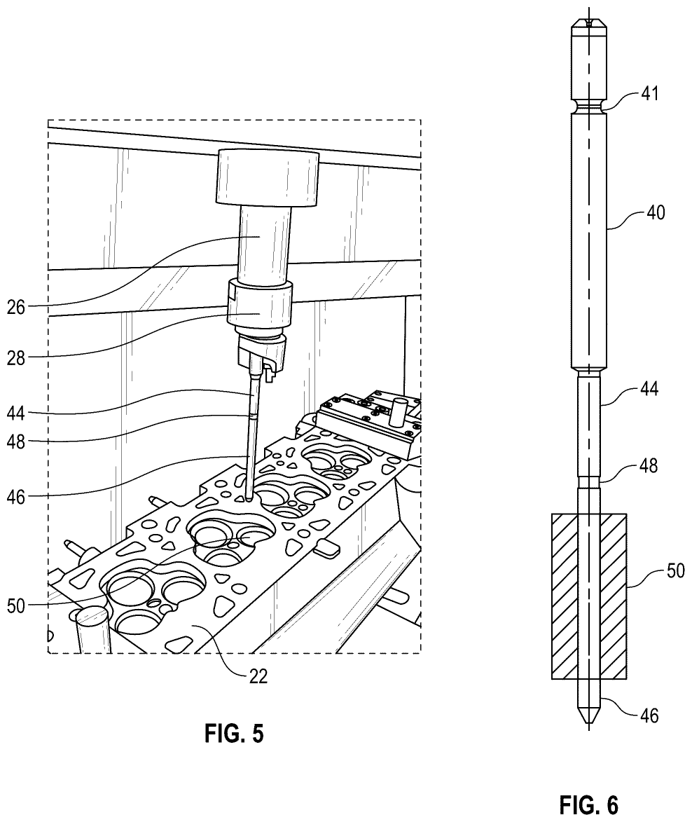

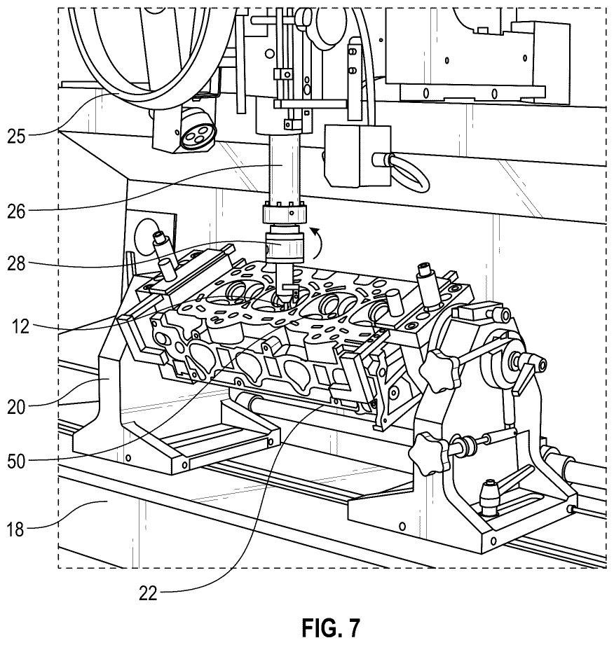

Now referring to FIG. 4, FIG. 5, FIG. 6 and FIG. 7, connecting pilot tool 12 to adapter 28 for operating pilot tool 12 as the live pilot is explained, in accordance with one embodiment of the present invention. FIG. 4 shows a perspective view of pilot tool 12 connected to adapter 28, which in turn connected to spindle 26. FIG. 5 shows an enlarged view of FIG. 4. In order to connect pilot tool 12 to adapter 28, at first, shank section 40 is inserted into an adapter bore of adapter 28. Subsequently, sphere-ball loaded spring 35 enters spherical groove 41 horizontally and locks shank section 40 in place. Here, shank section 40 is pushed up into the adapter bore such that majority of shank section 40 positions within the adapter bore exposing just about first section 44 and second section 46. Subsequently, an auxiliary tool is used to lock set screw 32 to lock adapter 28. Examples of the auxiliary tool includes an L-shaped tool or Allan key used for tightening or loosening set screw 32. In this embodiment, spring 36 allows pilot tool 12 via shank section 40 to have slight vertical movement within the adapter bore. The vertical movement allows pilot tool 12 to move up and down due to the compression forces encountered during the centering of valve guide 50.

After installing, spindle 26 is lowered such that second portion 46 contacts valve guide 50. FIG. 6 shows a schematic view of pilot tool 12 engaged within valve guide 50, in accordance with one embodiment of the present invention. Further, FIG. 7 shows a perspective view of pilot tool 12 in operation inside valve guide 50. As can be seen, second section 46 of pilot tool 12 contacts valve guide bore 50. After positioning, an operator (not shown) operates machine 14 such that spindle 26 rotates. Spindle 26 is operated to rotate at a desired speed in rotations per minute (RPM). The rotational speed of spindle 26 causes pilot tool 12 to rotate at the same speed as spindle 26. Second section 46 rotates along with spindle 26 and ensures continuous contact with valve guide 50. In one example, second section 46 rotates within valve guide 50 with a clearance of about 10 microns. As pilot tool 12 rotates, it causes valve guide 50 to align with the centerline of valve guide 50 with that of spindle 26 centerline/axis. This way, second section 46 positions in valve guide 50 utilizing pilot tool 12 as the live pilot for centering. A person skilled in the art understands that second section 46 helps in better centering of valve guide 50 due to the rotating nature of pilot tool 12 with spindle 26.

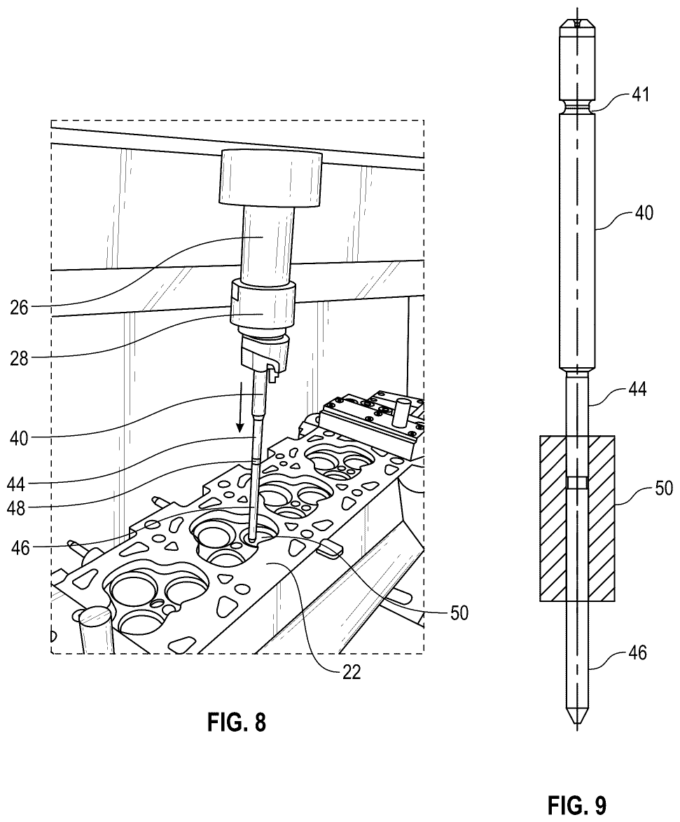

In another embodiment, pilot tool 12 is utilized as a fixed pilot for centering valve guide 50. In order to use pilot tool 12 as the fixed pilot, the auxiliary tool is used to loosen set screw 32. Further, shank section 40 is lowered such that extended section 42 comes down (as shown in FIG. 8), from the position shown in FIG. 5 (of live pilot). This way, second section 46 is made to extend down from adapter 28. After positioning pilot tool 12, the auxiliary tool is used to tighten set screw 32 such that shank section 40 connects to adapter 28. Subsequently, spindle 26 is lowered until tapered first section 44 wedges itself into a tapered section of valve guide 50. FIG. 9 shows schematic view of pilot tool 12 engaged within valve guide 50, in accordance with one embodiment of the present invention. Specifically, tapered first section 44 frictionally wedges itself into the tapered section of valve guide 50. After positioning tapered first section 44 into the tapered section of valve guide 50, adapter 28 is made to rotate. Here, tapered first section 44 of pilot tool 12 creates a secure and centered fit with valve guide 50 and centers valve guide 50 as spindle 26 rotates.

The operator switches pilot tool 12 to operate it as the fixed pilot and the live pilot by adjusting the position of shank section 40 within the adapter bore. This reduces the time needed for separate pilot tools for centering valve guide 50 in a fixed pilot system and a live pilot system as in the prior art. Adapter 28 encompasses sphere-ball loaded spring 35 to receive shank section 40. The position of shank section 40 is adjusted within the adapter bore to be able to use single pilot tool 12 as the fixed pilot system and the live pilot system depending on the concentricity of centering required. As pilot tool 12 remains connected to adapter 28, the operator adjusts the position of spindle 26 by operating hand wheel 25 to align spindle 26 from one valve guide 50 another valve guide 50 for centering. It should be understood that pilot tool 12 is adjusted to operate from being the live pilot to the fixed pilot by unscrewing set screw 32. Unscrewing set screw 32 causes pilot tool 12 to move freely within spindle 26 under the force of spring 36. Here, pilot tool 12 does not come out of adapter 28 as the distal end of shank section 40 locks into sphere-ball loaded spring 35. When pilot tool 12 needs to be used as the fixed pilot, then sphere-ball loaded spring 35 gets free from spherical groove 41 and slides over the spindle surface to the length desired for cutting/centering valve guide 50.

Based on the above, it is evident that the presently disclosed apparatus helps to center a valve guide with a centerline of the spindle for valve seat cutting machining. The apparatus includes a uniquely designed pilot tool having an upper tapered section and a lower straight section. The apparatus further includes an adapter for receiving the pilot tool at various lengths. Further, the adapter has a sphere-ball loaded spring that locks into a spherical groove at a shank section of the pilot tool. A spring at the top of the pilot tool inserts into the adapter bore and allows the pilot tool to be inserted within at different lengths. This allows the shank section to be connected to the adapter at different lengths thereby allowing the upper tapered section or the lower straight section to engage with the tapered valve guide or the valve guide bore, respectively. As presented above, the pilot tool remains connected to the adapter and the operator adjusts the position of the spindle by operating the hand wheel to align the spindle with another valve guide for centering. This way, the presently disclosed apparatus greatly reduces time between centering two or more valve guides when compared to prior art even when the pilot tool has to be switched from the fixed pilot system to the live pilot system, or vice versa. The pilot tool presents a two-in-one (2-in-1, or live+pilot) pilot tool that offers both fixed and live pilot. As a result, there is no need for the operator to use separate tools for centering utilizing the fixed pilot system and the live pilot system.

A person skilled in the art appreciates that the apparatus for centering a valve guide can come in a variety of shapes and sizes depending on the need. Further, many changes in the design and placement of components may take place without deviating from the scope of the presently disclosed apparatus.

In the above description, numerous specific details are set forth such as examples of some embodiments, specific components, devices, methods, in order to provide a thorough understanding of embodiments of the present invention. It will be apparent to a person of ordinary skill in the art that these specific details need not be employed, and should not be construed to limit the scope of the invention.

In the development of any actual implementation, numerous implementation-specific decisions must be made to achieve the developer's specific goals, such as compliance with system-related and business-related constraints. Such a development effort might be complex and time-consuming, but may nevertheless be a routine undertaking of design, fabrication, and manufacture for those of ordinary skill. Hence as various changes could be made in the above constructions without departing from the scope of the invention, it is intended that all matter contained in the above description or shown in the accompanying drawings shall be interpreted as illustrative and not in a limiting sense.

The foregoing description of embodiments is provided to enable any person skilled in the art to make and use the invention. Various modifications to these embodiments will be readily apparent to those skilled in the art, and the novel principles and invention disclosed herein may be applied to other embodiments without the use of the innovative faculty. It is contemplated that additional embodiments are within the spirit and true scope of the disclosed invention.

I/We claim:

1. An apparatus for centering a pilot tool within a valve guide during valve seat cutting, said apparatus comprising:
a pilot tool, comprising:
a shank; and
an extended section, wherein said extended section extends from said shank, wherein said extended section comprises an upper section and a lower section, wherein said upper section extends from said shank, and said lower section extends from said upper section, and wherein said upper section has a profile different from said lower section; and
an adapter, wherein said adapter receives said shank,
wherein said upper section engages with a valve guide to operate said pilot tool as a fixed pilot to center within said valve guide, or
wherein said lower section operatively contacts said valve guide, and wherein said adapter rotates causing said lower section to rotate and operate said pilot tool as a live pilot to center within said valve guide.

2. The apparatus of claim 1, wherein said upper section comprises a tapered section.

3. The apparatus of claim 2, wherein said lower section comprises a straight section.

4. The apparatus of claim 1, wherein said shank comprises a spherical groove.

5. The apparatus of claim 4, wherein said adapter comprises a sphere-ball loaded spring, and wherein said sphere-ball loaded spring slides over the surface of said shank and locks said shank to said adapter.

6. The apparatus of claim 1, wherein said shank comprises a spring, and wherein said spring positions within a bore of said adapter and helps to adjust the length exposed from said adapter.

7. The apparatus of claim 1, wherein said pilot tool remains connected to said adapter after centering said valve guide.

8. The apparatus of claim 7, wherein said pilot tool is lifted with said adapter by operation of a hand wheel of a valve seat and guide machine for placing said pilot tool in another valve guide.

9. The apparatus of claim 1, wherein said extended section comprises a groove between said upper section and said lower section, and wherein said groove acts as a reference point for each of said upper section and said lower section.

10. The apparatus of claim 1, wherein said pilot tool connects to said adapter using a set screw.

11. An apparatus for centering a pilot tool within a valve guide during valve seat cutting, said apparatus comprising:
a pilot tool, comprising:
a shank; and
an extended section, wherein said extended section extends from said shank, wherein said extended section comprises a tapered section and a straight section, and wherein said tapered section extends from said shank, and said straight section extends from said tapered section; and
an adapter, wherein said adapter receives said shank,
wherein said tapered section engages with a valve guide to operate said pilot tool as a fixed pilot to center within said valve guide, or
wherein said straight section operatively contacts said valve guide, and wherein said adapter rotates causing said straight section to rotate and operate said pilot tool as a live pilot to center within said valve guide.

12. The apparatus of claim 11, wherein said shank comprises a spherical groove.

13. The apparatus of claim 12, wherein said adapter comprises a sphere-ball loaded spring, and wherein said sphere-ball loaded spring slides over the surface of said shank and locks said shank to said adapter.

14. The apparatus of claim 11, wherein said shank comprises a spring, and wherein said spring positions within a bore of said adapter and helps to adjust the length exposed from said adapter.

15. The apparatus of claim 11, wherein pilot tool remains connected to said adapter after centering said valve guide.

16. The apparatus of claim 15, wherein said pilot tool is lifted with said adapter by operation of a hand wheel of a valve seat and guide machine for placing said pilot tool in another valve guide.

17. The apparatus of claim 11, wherein said extended section comprises a groove between said tapered section and said straight section.

18. A method of providing an apparatus for centering a pilot tool within a valve guide during valve seat cutting, said method comprising the steps of:
providing a pilot tool comprising a shank, and an extended section extending from said shank;
providing an upper section and a lower section at said extended section, said upper section extending from said shank, and said lower section extending from said upper section, said upper section having a profile different from said lower section;
providing an adapter for receiving said shank; and
centering a valve guide, by:
engaging said upper section with said valve guide to operate said pilot tool as a fixed pilot to center within said valve guide, or
operatively engaging said lower section with said valve guide, said adapter rotating for causing said lower section to rotate and operate said pilot tool as a live pilot to center within said valve guide.

19. The method of claim 18, further comprising providing a tapered section at said upper section, and a straight section at said lower section.

20. The method of claim 18, further comprising:
providing a spherical groove at said shank;
providing a sphere-ball loaded spring at said adapter, and
locking said shank to said adapter when said pilot tool is used as said live pilot.
